(19) United States
(12) Patent Application Publication
(10) Pub. No.: US 2014/0189735 A1
(43) Pub. Date: Jul. 3, 2014

(54) STREAMING MEDIA BUFFER POINTS REFLECTING USER BEHAVIOR AND INTERESTS

(71) Applicant: International Business Machines Corporation, Armonk, NY (US)

(72) Inventors: Gary D. Cudak, Creedmoor, NC (US); Lydia M. Do, Raleigh, NC (US); Christopher J. Hardee, Raleigh, NC (US); Adam Roberts, Moncure, NC (US)

(73) Assignee: International Business Machines Corporation, Armonk, NY (US)

(21) Appl. No.: 13/954,684

(22) Filed: Jul. 30, 2013

Related U.S. Application Data
(63) Continuation of application No. 13/731,312, filed on Dec. 31, 2012.

(51) Int. Cl. H04N 21/472

(52) U.S. Cl. CPC H04N 21/47217
USPC 725/38

(57) ABSTRACT

A method of handling streaming media includes identifying multiple seek points within media data streamed from a media source to a media player. A segment of the media data stream is buffered at each seek point. A graphical user interface illustrates the positions of the multiple seek points along a progress bar and identifies, for each of the multiple seek points, the source that provided the seek point. The method monitors for user input selecting a seek point from among the multiple seek points, and sets the selected seek point as a current playback point. The source of each seek point may, for example, be illustrated with a source identifying color, icon, or text description.

### CROSS-REFERENCE TO RELATED APPLICATIONS

This application is a continuation of co-pending U.S. patent application Ser. No. 13/731,312, filed on Dec. 31, 2012.

### BACKGROUND

1. Field of the Invention

The present invention relates to streaming media and methods for buffering media at multiple seek points.

2. Background of the Related Art

In a client-server streaming media environment, a media server streams media data to a client media receiver for playback. In such an environment, the client media receiver may buffer only a few seconds worth of media samples before playback, discarding those samples once playback has occurred.

Some media receivers may have operating modes other than normal speed playback. One common operation is a seek operation, in which a user may request the current playback position within the media stream to jump ahead or behind a current playback location to other locations in the media stream. As a specific example, a media receiver receiving movie data from a digital video disc (DVD) player may allow a user to jump between start points of chapters or scenes in the movie Likewise, a media receiver receiving media data from a digital video recorder (DVR) may allow a user to jump a set number of seconds forward or backward within a media data stream.

During such seek operations, a media receiver may flush currently buffered data and request new media samples from the server or other streaming media source for the new playback position. However, the request and receipt of the new media samples may take some time due to network latency, which may be perceived by a viewer as a pause before playback begins at the requested seek point.

Some streaming technologies have attempted to overcome such latency by using a form of streaming called “progressive download” in which an entire media stream is downloaded and stored local to the media receiver. However, such methods may not be suitable for use on media receivers that have limited local storage. Further, such methods only improve performance at a requested seek point if the media stream has been buffered past the requested seek point.

### BRIEF SUMMARY

One embodiment of the present invention provides a method of handling streaming media. The method includes identifying multiple seek points within a stream of media data streamed from a media source to a media player. A segment of the stream of media data is buffered at each of the multiple seek points. A graphical user interface illustrates the positions of the multiple seek points along a progress bar and identifies, for each of the multiple seek points, the source that provided the seek point. The method monitors for user input selecting a seek point from among the multiple seek points, and sets the selected seek point as a current playback point.

### BRIEF DESCRIPTION OF THE SEVERAL VIEWS OF THE DRAWINGS

FIG. 1 is a diagram of a media player.

FIG. 2 is a diagram of a media player progress bar using color to indicate the source of each seek point.

FIG. 3 is a diagram of a media player progress bar using icons to indicate the source of each seek point.

FIG. 4 is a diagram of a media player progress bar using text to indicate the source of each seek point.

FIG. 5 is a line graph of a user's past use of seek points.

FIG. 6 is a bar graph showing how frequently a user has used seek points from various sources.

FIG. 7 is a diagram of a computer capable of running a print manager application in accordance with various embodiments of the present invention.

FIG. 8 is a flowchart of one embodiment of a method of the present invention.

### DETAILED DESCRIPTION

One embodiment of the present invention provides a method of handling streaming media. The method includes identifying multiple seek points within a stream of media data streamed from a media source to a media player. A segment of the stream of media data is buffered at each of the multiple seek points. A graphical user interface illustrates the positions of the multiple seek points along a progress bar and identifies, for each of the multiple seek points, the source that provided the seek point. The method monitors for user input selecting a seek point from among the multiple seek points, and sets the selected seek point as a current playback point.

In a further embodiment, the multiple seek points are provided by at least two different sources. Preferably, at least one of the sources is external to a device that operates the media player. Where there are buffered segments for multiple seek points, the buffered segments are separated from each other buffered segment of the stream of media data by a segment of unbuffered data of the stream of media data.

In various embodiments, the appearance of each seek point may indicating the source of that seek power. In other words, for each of the multiple seek points, the source of the seek point is identified by an appearance that is unique to the source that provided the seek point. For example, the appearance that is unique to the source or type of source may include color, wherein a different color or shading is used for each source. In a specific instance, a seek point may be colored blue when created by user profiling, red when received from a social media (i.e., Facebook) group, or orange the user has previously tagged the seek point.

In a separate example, the appearance that is unique to the source or type of source may include icons, wherein a different icon is used for each source. In a still further example, the source that provided the seek point may be identified by including a text description of the source.

According to certain embodiments of the invention, at least one of the sources of a seek point is external to a device that operates the media player. For example, the external source may be another user that is identified in a contact list designated by the user. In another example, the external source may be a third party media source, wherein the seek point received from the third party media source is based upon popularity of seek points for the particular stream of media data. Still further, the media player may prioritize the receipt and display of seek points from third party individual users having similar user profiles, even if they are not identified in a contact list. Accordingly, the request for seek points may be sent to a website, such as a social media service, wherein the request includes some portion of the user's profile for matching with other user profiles, then accessing seek points tagged by those other users.

A further embodiment of the present invention includes developing a user profile based upon past use of seek points in the media player. In a first example, the user profile may identify a segment length of a media stream that the user frequently watches. Accordingly, the method may further include setting a buffer length for one or more of the seek points based upon the segment length identified in the user profile. In a second example, the user profile may identify how often a user skips an earlier seek point for a later seek point. Here, the method may further include setting a buffer length for one or more of the seek points based upon how often the user skips an earlier seek point for a later seek point in the user profile. If a user frequently skips a first seek point, then the method would set a longer buffer length for seek points other than the first seek point. In still further example, the user profile may identifies at least one of the multiple seek points, one or more points of a media stream that are typically of interest to the user, or one or more points of a media stream that the user typically skips. Certainly, if the user profile indicates that the user never watches more than two minutes of any single media stream, then there is no need to buffer the media stream beyond two minutes from any given seek point.

It should be recognized that the multiple seek points, where media data has been buffered, may be viewed in any manner desired by the user. Optionally, the entire media stream or file does not need to be buffered before the user is allowed to view the content. In one not limiting example, a segment of a media file may be identified by a notation that identifies start and end times, such as 0:23-1:44 (indicating the segment start time in minutes:seconds and the segment end time in minutes:seconds).

The user may view clips at the seek points in sequential order (i.e. 1st seek point, followed by 2nd seek point, etc.), or in a re-ordered manner (i.e. 1st seek point at time 3:10, 2nd seek point at time 1:25). The order of viewing may be affected by the general popularity of the segments, the available network bandwidth, or whether a social media friend or contact of the user has referenced or recommended a particular segment of the stream to view first. A “seek point” may be alternatively referred to as a “tag”, “link” or “mark”. The user's actions, either to use a particular seek point or not, may feedback into the further development of the user profile.

In an alternative embodiment, users may save their recommended buffer points at the source of the streaming media, such as the server of a media streaming website. Then, the user's media player or browser will access the same media streaming website, identify themselves, and view the seek points that were previously saved by a person named in their contacts or friend list. According to this alternative, the desired buffer points would be downloaded to the user's media player or browser from the same source as the streaming video. This and other server-side embodiments may also track behavior across multiple users and normalize the buffer locations accordingly.

In a further embodiment, seek points are identified or obtained from external sources using polling. When a user has selected streaming media for download, the media player or browser may send a request to any number of external sources, preferably those external sources previously identified to the media player or browser by the user. For example, the media player may allow the user to establish a contacts list or preferred social media. The request is sent to the users or websites in the contact list to solicit one or more seek points, which those users or websites may have already tagged. Accordingly, a response including one or more seek points may be quickly received and used in accordance with one or more embodiment of the invention, such as to guide buffering and be included in a graphical user interface. If one of the contacts has not yet accessed the media file, or chose not to tag the media file, then no seek point is received from that contact.

Various embodiments of the invention may be embodied in a media player or viewer, a web browser, or a web-based streaming media service provider, such as Youtube.

Another embodiment of the invention provides a computer program product including computer usable program code embodied on a tangible computer usable storage medium. The computer program product comprises: computer usable program code for identifying multiple seek points within a stream of media data streamed from a media source to a media player; computer usable program code for buffering a segment of the stream of media data at each of the multiple seek points; computer usable program code for providing a graphical user interface illustrating the positions of the multiple seek points along a progress bar and identifying, for each of the multiple seek points, the source that provided the seek point; computer usable program code for monitoring for user input selecting a seek point from among the multiple seek points; and computer usable program code for setting the selected seek point as a current playback point.

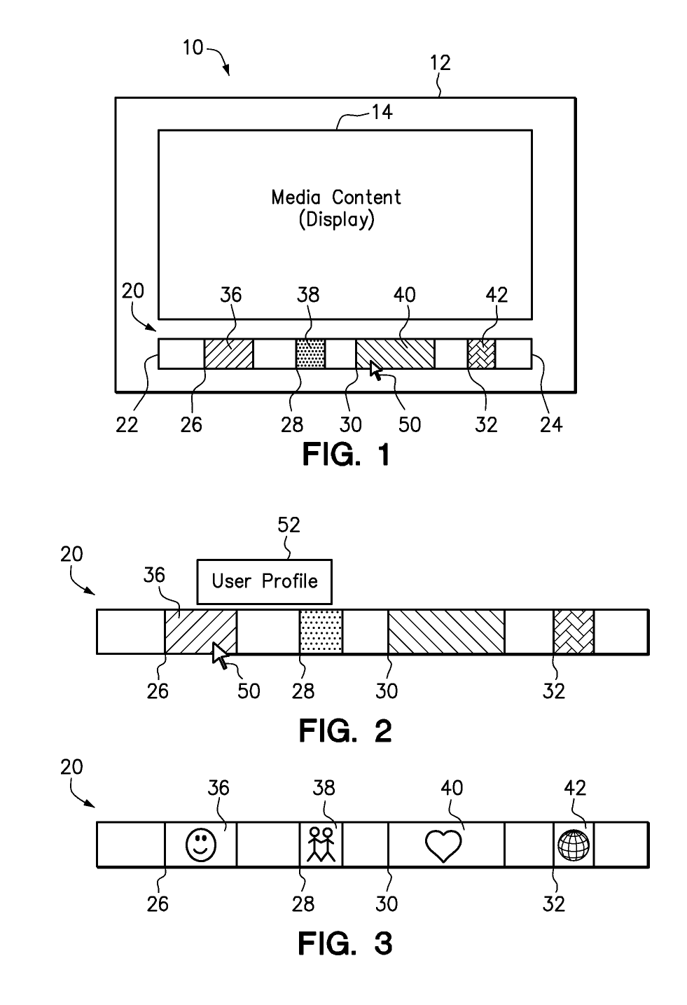

FIG. 1 is a diagram of a media player 10. The media player 10 includes a graphical user interface 12 that is displayed to a user. Although some media players only handle audio, the media player 10 is capable of both audio and video and includes an video area 14 for displaying any video content. Below the video area 14 is a progress bar 20 that can be used to represent the media file or content that has been selected. The left end 22 of the progress bar represents the beginning of the media file and the right end 24 represents the end of the media file. This is generally true whether the media file runs for 30 seconds or 45 minutes, although the total runtime may be noted beside the progress bar. Accordingly, seek points 26, 28, 30, 32 are displayed on the progress bar using a normalized scale. Similarly, buffer zones 36, 38, 40, 42 corresponding to the respective seek points 26, 28, 30, 32 are preferably displayed using the same normalized scale. A pointer 50 may be controlled by a mouse or track pad, for example, in order to select one of the seek points.

FIG. 2 is a diagram of the media player progress bar 20 using color to indicate the source of each of the four seek points 26, 28, 30, 32. As shown, a unique color (represented here by unique shading) is provided across the buffer zone associated with the seek point. For example, the buffer zone 36 associated with the first seek point 26 is shown having a certain color (shading). If desired, the graphical user interface 12 (See FIG. 1) may also display a legend that identifies the source that corresponds with the color. As shown, the pointer 50 is hovering over the buffer zone 36, such that a pop up window 52 further identifies the source of the associated seek point 26. As shown, the first seek point 26 has been identified using a user profile.

FIG. 3 is a diagram of a media player progress bar 20 using icons to indicate the source of each seek point 26, 28, 30, 32. A first icon is in the buffer zone 36 associated with seek point 26 to identify the source as the user profile, a second icon is in the buffer zone 38 associated with seek point 28 to identify the source as a contact list, a third icon is in the buffer zone 40 associated with seek point 30 to identify the source as a social media website, and a fourth icon is in the buffer zone 42 associated with seek point 32 to identify the source as an internet search engine.

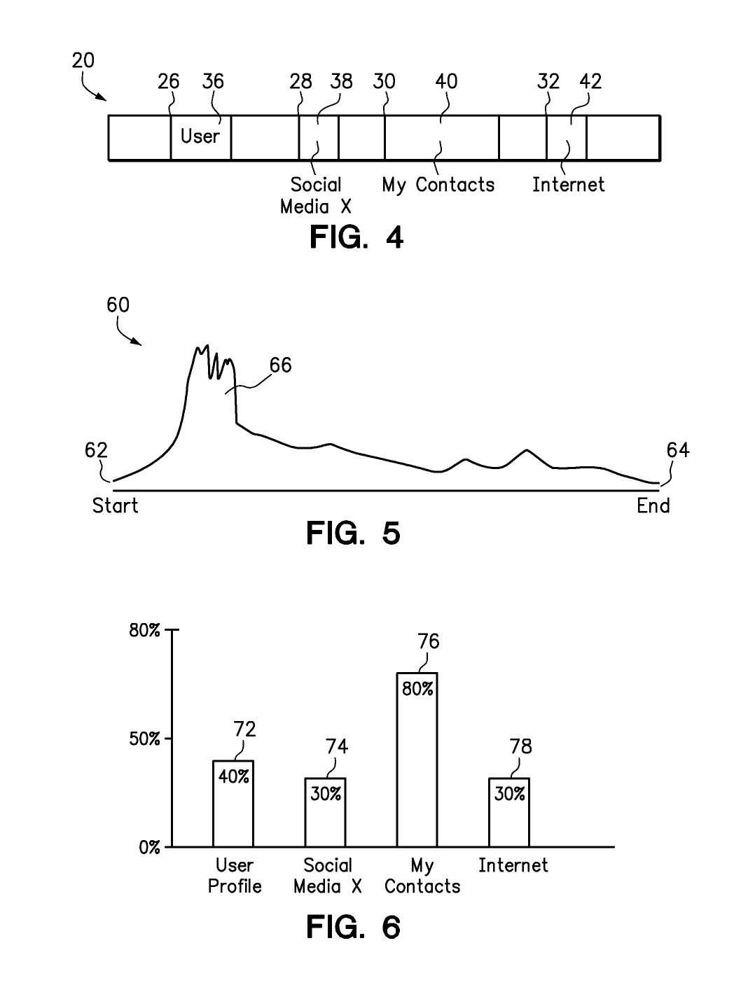

FIG. 4 is a diagram of a media player progress bar 20 using text to indicate the source of each seek point 26, 28, 30, 32. As shown, the text may overlay the progress bar 20, as with the text “User” in buffer zone 36, or may be displayed adjacent the seek point or buffer zone. Optionally, a lead line may be utilized to indicate with seek point or buffer zone is associated with the text.

FIG. 5 is a line graph of a user's past use of seek points. A media player uses statistical analysis to generate useful data about the user's historical media viewing and/or listening habits. For a given user, the graph shows that the user typically skips an introduction portion of media, then watches for a period 66 before being fairly decisive about whether or not to continue with the media. Accordingly, the peak region 66 from the user profile (per FIG. 5) is used as the basis for identifying the seek point 26 shown in FIG. 4. Furthermore, the user profile data of FIG. 5 shows the duration that the user will frequently watch or listen to media. Accordingly, the breadth of the peak region 66 corresponds with the length of the buffer zone 36 that is associated with the seek point 26 in FIG. 4.

FIG. 6 is a bar graph showing how frequently a user has in the past used seek points from various sources. A first bar 72 indicates that a seek point from the user profile is used by this user about 40% of the time that media is viewed. A second bar 74 indicates that a seek point from social media is used or selected by this user about 30% of the time, a third bar 76 indicates that a seek point from the user's contacts is used or selected by this user about 70% of the time, and a fourth bar 78 indicates that a seek point from an alternative internet source is used or selected by this user about 30% of the time. The usage of these seek points does not need to add to 100%, since a user may use multiple seek points with a single media file. Since this user is more likely to selected a seek point from one of their contacts (i.e., a user in their “My Contacts” list), the media player has determined that the length of the buffer zone 40 should be longer than the other buffer zones 36, 38, 42 (See FIG. 4).

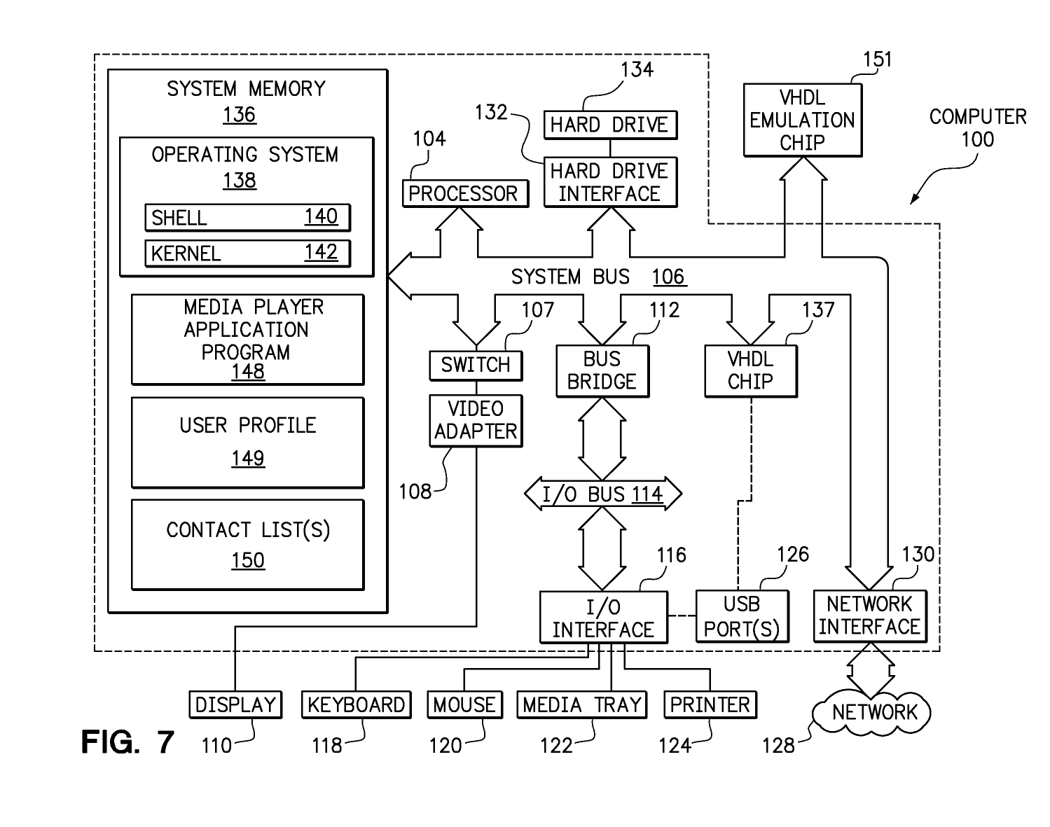

FIG. 7 is a diagram of a computer capable of running a media player application or browser in accordance with various embodiments of the present invention. Note that some or all of the exemplary architecture, including both depicted hardware and software, shown for and within the computer 100 may be implemented in the server 100 shown in FIG. 1.

Computer 100 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, the computer 100 is able to communicate over a network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 100. This volatile memory includes additional higher levels of volatile memory (not shown), including, but not limited to, cache memory, registers and buffers. Data that populates system memory 136 includes the computer's operating system (OS) 138 and application programs 144. For example, the system memory 136 may further include a media play application program 148, with access to a user profile 149 and one or more contact lists 150 for use in accordance with embodiments of the invention described herein.

The operating system 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc. As depicted, the OS 138 also includes kernel 142, which includes lower levels of functionality for the OS 138, including providing essential services required by other parts of OS 138.

The system memory 136 may also include a VHDL (VHSIC hardware description language) program. VHDL is an exemplary design-entry language for field programmable gate arrays (FPGAs), application specific integrated circuits (ASICs), and other similar electronic devices. In one embodiment, execution of instructions from a VMPP causes a VHDL program to configure the VHDL chip 137, which may be an FPGA, ASIC, or the like.

In another embodiment of the present invention, execution of instructions from VMPP results in a utilization of VHDL program to program a VHDL emulation chip 151. VHDL emulation chip 151 may incorporate a similar architecture as described above for VHDL chip 137. Once VMPP and VHDL program the VHDL emulation chip 151, VHDL emulation chip 151 performs, as hardware, some or all functions described by one or more executions of some or all of the instructions found in VMPP. That is, the VHDL emulation chip 151 is a hardware emulation of some or all of the software instructions found in VMPP. In one embodiment, VHDL emulation chip 151 is a programmable read only memory (PROM) that, once burned in accordance with instructions from VMPP and VHDL program, is permanently transformed into a new circuitry that performs the functions needed to perform the processes of the present invention.

The hardware elements depicted in computer 100 are not intended to be exhaustive, but rather are representative devices suitable to perform the processes of the present invention. For instance, computer 100 may include alternate memory storage devices such as magnetic cassettes, digital versatile disks (DVDs), Bernoulli cartridges, and the like. These and other variations are intended to be within the spirit and scope of the present invention.

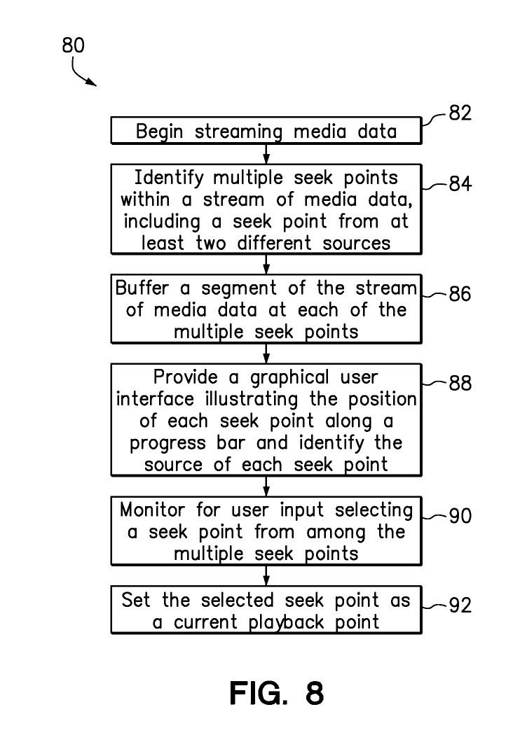

FIG. 8 is a flowchart of one embodiment of a method 80 of the present invention. In step 82, the method begins to stream media data. Step 84 includes identifying multiple seek points within a stream of media data streamed from a media source to a media player, wherein the multiple seek points are provided by at least two different sources. In various embodiments, at least one of the sources is external to a device that operates the media player. In step 86, the media player buffers a segment of the stream of media data at each of the multiple seek points. Much of the buffering occurs prior to receiving a seek request from a user to skip to one of the multiple seek points, and each buffered segment is typically separated from each other buffered segment of the stream of media data by a segment of unbuffered data of the stream of media data. Step 88 provides a graphical user interface illustrating the position of each seek point along a progress bar and identifying the source of each seek point. In step 90, the method monitors for user input selecting a seek point from among the multiple seek points, and in step 92 the method sets the selected seek point as a current playback point.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
identifying multiple seek points within a stream of media data streamed from a media source to a media player;
buffering a segment of the stream of media data at each of the multiple seek points;
providing a graphical user interface illustrating the positions of the multiple seek points along a progress bar and identifying, for each of the multiple seek points, the source that provided the seek point;
monitoring for user input selecting a seek point from among the multiple seek points; and
setting the selected seek point as a current playback point.

2. The method of claim 1, wherein the multiple seek points are provided by at least two different sources, and wherein at least one of the sources is external to a device that operates the media player.

3. The method of claim 1, wherein each buffered segment is separated from each other buffered segment of the stream of media data by a segment of unbuffered data of the stream of media data.

4. The method of claim 1, wherein, for each of the multiple seek points, the source of the seek point is identified by an appearance that is unique to the source that provided the seek point.

5. The method of claim 4, wherein the appearance that is unique to the source or type of source includes color, wherein a different color is used for each source.

6. The method of claim 4, wherein the appearance that is unique to the source or type of source includes icons, wherein a different icon is used for each source.

7. The method of claim 1, wherein the source that provided the seek point is identified by including a text description of the source.

8. The method of claim 1, wherein the at least one of the sources that is external to a device that operates the media player is another user identified in a contact list designated by the user.

9. The method of claim 1, wherein the at least one of the sources that is external to a device that operates the media player is a third party media source, and wherein the seek point received from the third party media source is based upon popularity of seek points for the particular stream of media data.

10. The method of claim 1, further comprising:
developing a user profile including past use of seek points in the media player.

11. The method of claim 10, wherein the user profile identifies a segment length of a media stream that the user frequently watches, the method further comprising:
setting a buffer length for one or more of the seek points based upon the segment length identified in the user profile.

12. The method of claim 10, wherein the user profile identifies how often a user skips an earlier seek point for a later seek point, the method further comprising:
setting a buffer length for one or more of the seek points based upon how often the user skips an earlier seek point for a later seek point in the user profile.

13. The method of claim 10, wherein the user profile identifies at least one of the multiple seek points.

14. The method of claim 12, wherein the user profile identifies one or more points of a media stream that are typically of interest to the user.

15. The method of claim 12, wherein the user profile identifies one or more points of a media stream that the user typically skips.
